(19) United States
(12) Patent Application Publication
(10) Pub. No.: US 2008/0263679 A1
(43) Pub. Date: Oct. 23, 2008

(54) STORING INFORMATION IN CLOSED COMPUTING DEVICES

(75) Inventors: Albert Sing Ho, Seattle, WA (US); Ronnie Donnell Yates, Bothell, WA (US); Richard Andrew Meyer, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/739,066

(22) Filed: Apr. 23, 2007

(51) Int. Cl. H04L 9/00

(52) U.S. Cl. 726/30

(57) ABSTRACT

Mechanisms for securely storing unsigned information in closed computing devices are disclosed. Unsigned media entities, such as independently developed games, can be stored in a closed computing device, such as a gaming console. The storing of media entities can include preventing any content, whether residing on the closed console or remotely, from accessing the unsigned media entities. In this aspect, unsigned media entities can be isolated from such content on a per unsigned media entity basis (the media entity being the unit of isolation). Moreover, the media entities can be stored in directory structures that logically isolate the unsigned media entities from any other content. The closed computing device can also use a directory structure to guarantee that a specified signed loader can load unsigned media entities. Once stored, the media entities can also be secured from tampering by using a unique hardware key associated with the closed computing device.

### CROSS-REFERENCE TO RELATED SUBJECT MATTER

The presently disclosed subject matter is related to the following applications: U.S. application Ser. No. 11/636,199, filed Dec. 7, 2006 (Attorney Docket No.: MSFT-5854/MS 319144.01), entitled “EXECUTING UNSIGNED CONTENT AND SECURING ACCESS IN A CLOSED SYSTEM”; U.S. application Ser. No. 11/636,219, filed Dec. 7, 2006 (Attorney Docket No.: MSFT-5855/MS 319145.01), entitled “TRANSFER OF CONTENT TO CLOSED SYSTEMS”; and, U.S. application Ser. No. 11/636,166, filed Dec. 7, 2006 (Attorney Docket No.: MSFT-5856/MS 319153.01), entitled “SUBSCRIPTION BASED SERVICES FOR CLOSED COMPUTING SYSTEMS.”

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2006, 2007 Microsoft Corp.

### FIELD OF TECHNOLOGY

The presently disclosed subject matter relates to the field of computing, and more particularly, to fields such as gaming and media content, although these are merely exemplary and non-limiting fields.

### BACKGROUND

Game consoles are prevalent in today's markets. Such game consoles are also typically closed systems that only allow signed games controlled by hardware vendors to execute on such consoles. This restriction may be done for various reasons, whether to preserve the business model of having a tightly controlled environment for publishers, where piracy of intellectual property is kept to a minimum, or controlling the types games that can be played on a gaming system, for instance, to allow content that meets parental expectations for children playing such content. Additionally, allowing signed code to run helps to control and mitigate the potential for cheating on games in an online community, where certain assumptions, such as community scores or digital currency, are essential to be accurate.

However, these tight restrictions present on game consoles prevent the larger creative community as a whole from developing games or game-like applications on closed game consoles. Thus, it is important to address the need of allowing developers, gamers, general hobbyist, and student game developer communities, among others, to write games for a traditionally closed system and then being able to store these games on closed systems. Additionally, it is important to address the problem of a burgeoning market of homebrew developers who spend the time and effort in order to hack game consoles in order to allow the running of unsigned code on such consoles. Thus, it would also be advantageous provide for secured storing of unsigned content.

### SUMMARY

Various mechanisms are disclosed herein for securely storing unsigned information in closed computing devices. In one aspect of the presently disclosed subject matter, unsigned media entities can be stored in memory of a closed computing device, where the storing can include preventing any content from accessing the unsigned media entities (and/or vice-versa). Thus, the unsigned media entities can be isolated from such content on a per unsigned media entity basis (the media entity forming the unit of isolation). Such media entities can include (but are not limited to) games, videos, songs, software, and just about any digital content.

The storing can further comprise storing the unsigned media entities in directory structures that logically isolate the unsigned media entities from any other content. The closed computing device can also use a directory structure to guarantee that a specified signed loader can load unsigned media entities that persists in a given directory or subdirectory of a directory structure. This structure can further be enforced by storing some or all the relevant hierarchical location information along with the content. Once stored, the media entities can also be secured from tampering by using a unique hardware key associated with the closed computing device.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are illustrated. However, the disclosure is not limited to the specific aspects shown. The following figures are included:

FIG. 1 illustrates that unsigned content, in addition to signed content, can be stored in persistent storage of game console devices, for instance, when it is provided from remote computing devices;

FIG. 2 illustrates that various types of information (e.g. code and/or data) can be stored in the mentioned persistent storage;

FIG. 3 illustrates that the modules shown in FIG. 2 may be isolated from one another based on various heuristics that are explored in more detail with reference to FIGS. 4 and 5;

FIG. 4 illustrates one exemplary and non-limiting aspect of the present disclosure, namely, how the sandbox mechanism can be implemented by storing information via a directory structure that logically isolates unsigned games from each other, as well as other signed content;

FIG. 5 illustrates that at least two kinds of mechanisms can be used to assure proper isolation and security when storing unsigned code and/or data (or signed code and/or data, for that matter);

FIG. 6 illustrates a system view of the presently disclosed subject matter with various types of stores, where this system incorporates at least the subject matter of FIGS. 3-5;

FIG. 7 illustrates a flow chart of an exemplary and non-limiting method implementation (and by extension a computer readable media implementation) of the presently disclosed subject matter;

FIG. 8 illustrates a block diagram of an exemplary multimedia console, whether a game oriented console or a general personal computer (PC), that can be used with the aspects discussed with reference to FIGS. 1-8; and

FIG. 9 illustrates an exemplary networking environment for subject matter discussed with reference to FIGS. 1-9.

### DETAILED DESCRIPTION

### I. Overview

Various mechanisms are disclosed herein for securely storing unsigned information in closed computing devices. By way of example and not limitation, unsigned media entities, such as independently developed games, can be stored in a closed computing device, such as a gaming console. The storing of media entities can include preventing any content, whether residing on the closed console or remotely, from accessing the unsigned media entities, or alternatively, from modifying them.

Depending on the aspect of the present disclosure, unsigned media entities can be isolated from such content on a per unsigned media entity basis (the media entity being the unit of isolation). Moreover, the media entities can be stored in directory structures that logically isolate the unsigned media entities from any other content. The closed computing device can also use a directory structure to guarantee that a specified signed loader can load unsigned media entities. This structure can further be enforced by storing some or all the relevant hierarchical location information along with the content. Once stored, the media entities can also be secured from tampering by using a unique hardware key associated with the closed computing device. In the following discussion, these and similar aspects are explored in more detail, and exemplary computing and networking environments are provided.

### II. Aspects of Storing Information in Closed Computing Devices

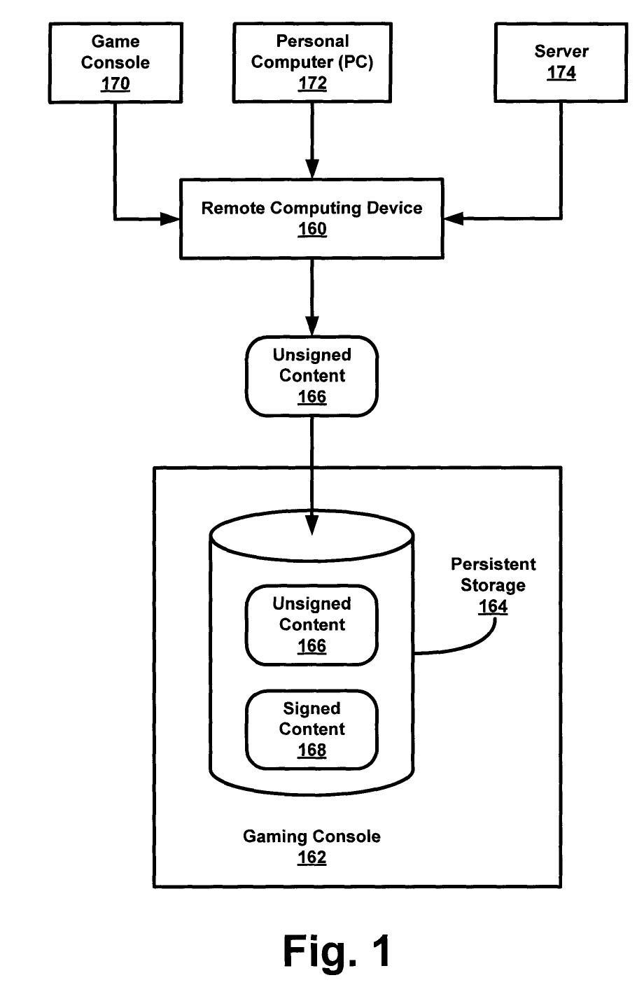

FIG. 1 illustrates that unsigned content, in addition to signed content, can be stored in persistent storage of game console devices. In this figure, a game console 170, a personal computer (PC) 172, and a server 174 are shown. These are exemplary and non-limiting types of remote computing devices 160 (i.e., remote vis-à-vis the gaming console 162). Numerous other computing devices are contemplated herein, such as personal digital assistants (PDAs), cell phones, and so on. Any of these remote computing devices 160 can send unsigned content 166 to a gaming console 162. Of course, the gaming console 162 itself is a type of computing device, as is exemplified by the remote computing device 160. Typically, signed and unsigned content is afforded different rights or are usable in different circumstances on a computing device. A common but non-limiting example is executable code must typically be signed in order to be executed.

Unsigned content, as it pertains to this document, refers to any content that does not bear a digital signature granting certain rights for that content on the computing device. Unsigned content can therefore refer to content bearing a digital signature, so long as that signature does not affect the device's handling of the content. In other words, traditional games, for example, may be signed by their publishers for any purpose (identification, compatibility, copyright, etc . . . ), but such games are still considered unsigned content unless that signature, or another on the same game, affords certain rights or treatment on the device in question. Unsigned content, in contrast, can be developed by anyone and it does not have to be signed (whether such signing is accomplished using cryptographic means, such as certificates and so on). In any event, those of skill in the art will readily appreciate the distinction between signed content and unsigned content.

Thus, FIG. 1 shows that unsigned content 166 is being sent by the remote computing device 160 and that it is eventually received by the gaming console 162. The gaming console 162 stores such unsigned content 166 in some persistent storage 164. Such persistent storage 164, in turn, may contain not only unsigned content 166, but also signed content 168. Thus, to sum up, in this aspect of the presently disclosed subject matter, FIG. 1 shows that unsigned content can be remotely supplied from a computing device 160 to a gaming console 162, and then that such unsigned content 166 can be stored in some persistent storage 164 associated with the gaming console 162.

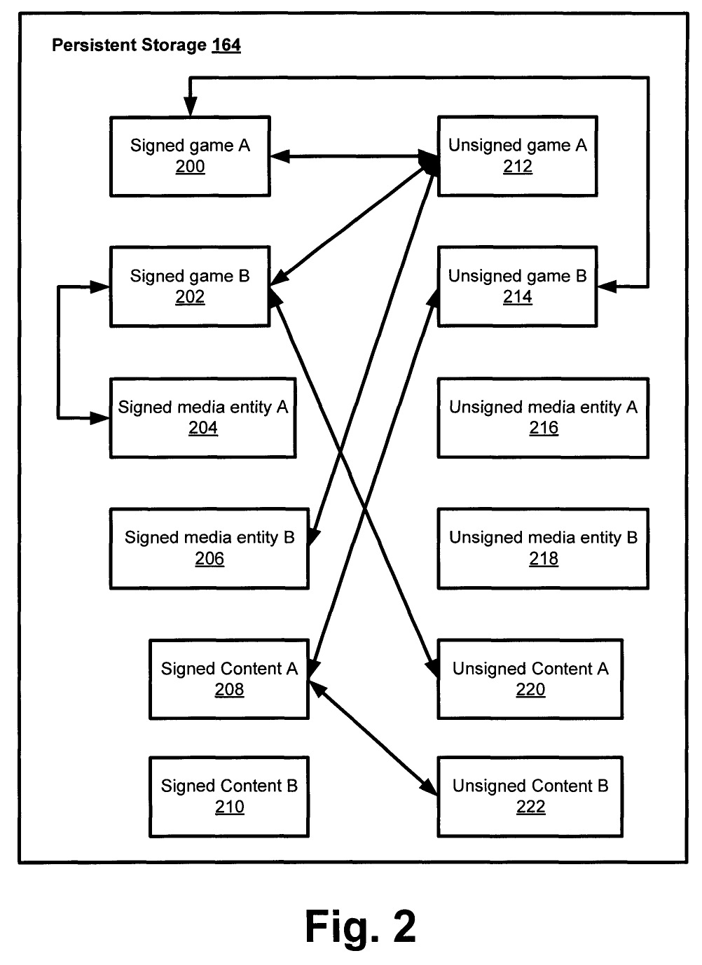

Next, FIG. 2 illustrates that various types of information (e.g. code and/or data) can be stored in the persistent storage 164. To follow up on FIG. 1, such information may be signed games A 200 and B 202, and unsigned games A 212 and B 214. The only limit as to the number of games that can be stored in the persistent storage 164 is only limited by the hardware limitations of the persistent storage 164.

FIG. 2 also shows that not only games can be stored, but rather all kinds of media entities. Media entities, of course, may include games but are not limited thereto. By way of example and not limitation, media entities may includes songs (in all kinds of formats), pictures, videos, and so on. Thus, FIG. 2 shows that signed media entity A 204 and B 206 can be stored along with unsigned media entities A 216 and B 218.

Furthermore, on a more abstract level, signed and unsigned content may be stored, where such content is not limited to media entities, but rather also may include software, various files, programs, and so on. Turning to FIG. 2, signed content A 208 and B 210 is stored in the persistent storage 164, along with unsigned content A 220 and B 222. It should be noted, even though this point is well understood by those of skill in the art, that such signed and unsigned content may be stored in various combinations. In one extreme example, only signed content may be stored or only unsigned content may be stored. In more typical scenarios, some combination of signed and unsigned content may be stored in the persistent storage 164.

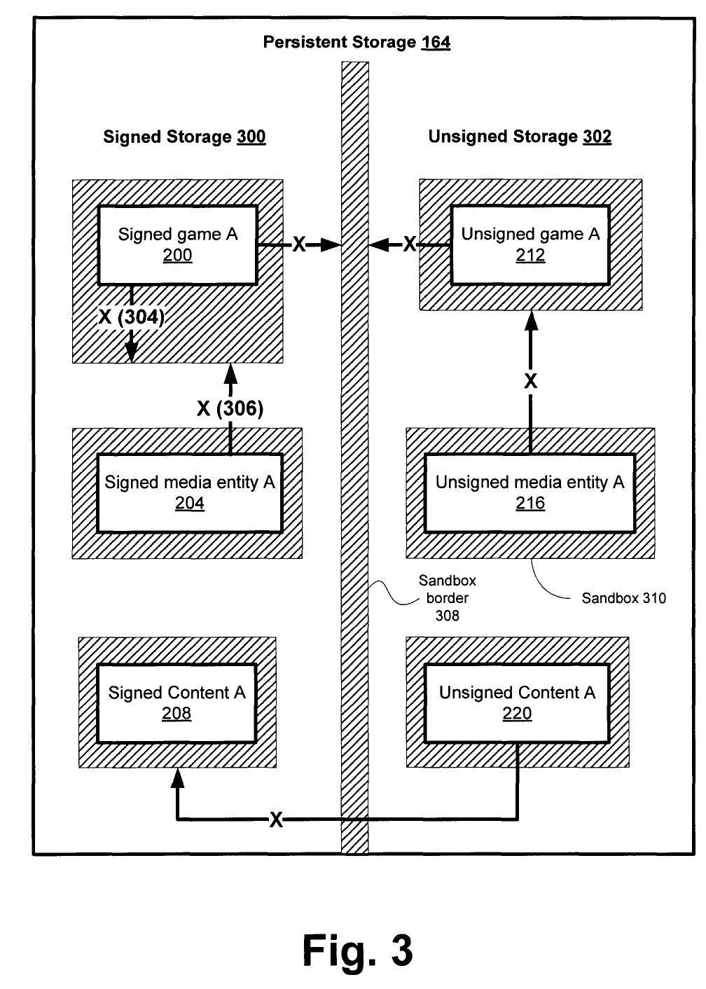

Such games 200, 202, 212, 214, media entities 204, 206, 216, 218, and content 208, 210, 220, 222 may want to interact with one another (however, such interaction is prevented as is shown in FIG. 3). For example, as is illustrated in FIG. 2, signed game A 200 may interact with unsigned game B 214. Such interaction could include the accessing of information (code and/or data), and loading of such information. If, for example, signed game A 200 is a popular title published by a publisher, unsigned game B 214 could be a game developed by an individual to interact with signed game A 200 (whether unsigned game B 214 acts as an add-on to signed game A 200 or an enhancement thereof, or for other purposes).

Interaction between signed games, media entities, and content can be varied. The arrows in FIG. 2 are meant to be exemplary and non-limiting. Thus, for instance, signed game B 202 can interact with signed media entity A 204 (e.g. a game title being played along with a song being played in the background, respectively; signed content A 208 can interact with unsigned game B 214 (e.g. a software module, such as a graphics enhancement module, can interact with a game developed by an individual developer in order to improve the graphics display of the game, respectively); and so on, a variety of relationships may be formed between games, media entities, and signed content. Those of skill in the art will readily appreciate the myriad of different functionalities the shown modules 200-222 can perform individually or in combination.

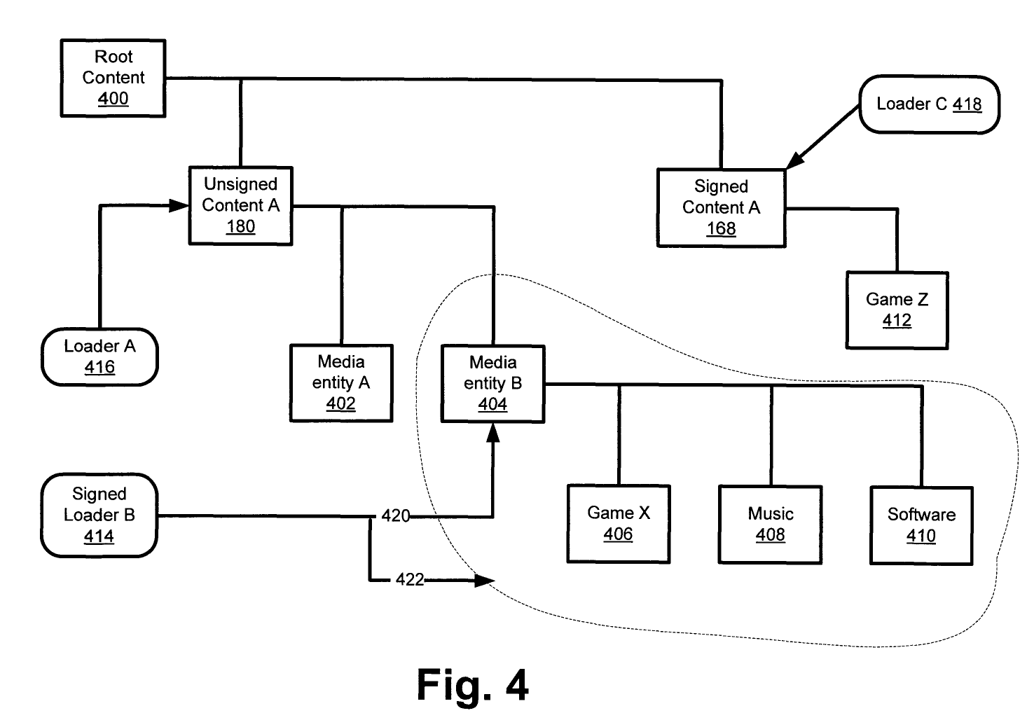

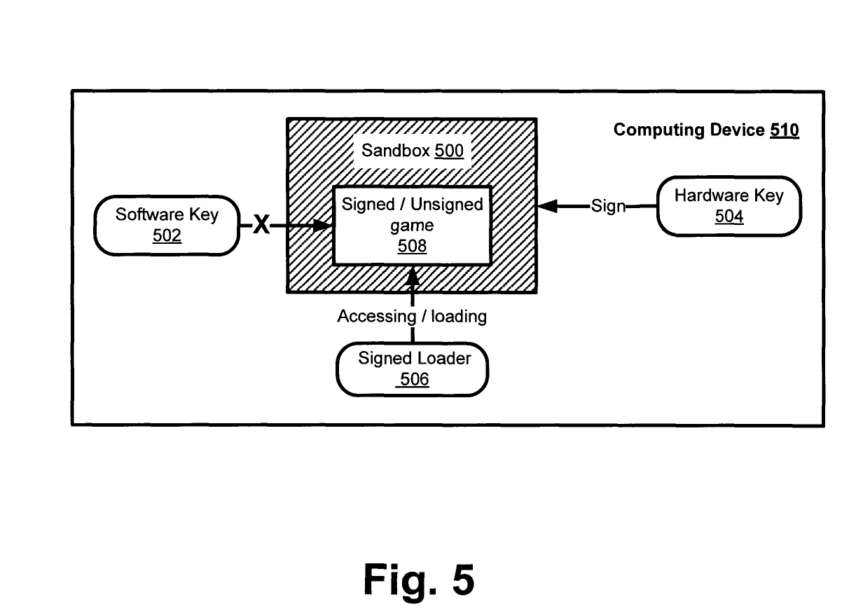

FIG. 3 illustrates that the modules shown in FIG. 2 may be isolated from one another based on various heuristics. For example, persistent storage 164 may be divided along the lines of signed storage 300 and unsigned storage 302. However, it does not have to be so isolated since it can be isolated on a per-game basis. In this aspect, each game, whether signed or unsigned, can be isolated from one another by a “sandbox” 306 whose properties are explored in detail at least with reference to FIGS. 4-5. Alternatively, in other aspects, only unsigned games could be so isolated from another (i.e. the signed games don't have to be so isolated). Still in other aspects, unsigned games can be isolated from one another and from signed games, but signed games do not have to be necessarily isolated from one another (but can be, in some aspects). The appropriate isolation regime will depend on the implementation details. Moreover, such isolation applies, per the discussion above, not only to games but also to media entities and other content.

Turning back now to FIG. 3, signed game A 200 can be isolated from signed media entity A 204 in the sense that this game 200 cannot access the media entity 204 (arrow 304), and/or it cannot be accessed by the media entity 204 (arrow 306). The other arrows illustrate that such access may be restricted among various games, entities, and content. One purpose of the isolation mechanism 310 is to keep information, i.e., code and/or data (whether in the form of games, media entities, or content) from accessing resources of a computing device. Such resources (not shown) may be reserved for other purposes than, say, what a particular unsigned game may want to use them. Since unsigned games can be developed just about by any individual and/or computing module, it is beneficial to control them via the sandbox mechanism 310.

FIG. 4 illustrates one exemplary and non-limiting aspect of the present disclosure, namely, how the sandbox mechanism can be implemented by storing information via a directory structure that logically isolates unsigned games from each other, as well as other signed content. In other words, certain directories can have mechanisms in place to guarantee that only specified signed loaders can load unsigned games within a given subdirectory. For instance, an enumerated list of loaders can be designated for a particular subdirectory. This list can be dynamic and thus subject to changes and updating. Furthermore, some or all of the hierarchical isolation layout can be encoded as part of the content entity itself, to prevent the manipulation of the isolation layout.

Turning now to FIG. 4, signed loader B 414 can be designated as the loader for media entity B 404, when such a media entity can be part of subdirectory of unsigned content A 180. In this aspect, only loader B 414 can load media entity B 404. In other aspects, this loader 414 and other loaders in the same family or set of loaders, can load media entity B 404. In still other aspects, signed loader B 414 can load media entity B 404 and any games, entities, and content that is part of the subdirectory of media entity B 404, i.e., in FIG. 4 this being game X 406, music 408, and software 410 (e.g. synchronizing software between various modules).

Thus, loader B 414 can load 420 the media entity B 404, and it can load 422 any other code and/or data that is a subdirectory thereof. In other words, it can load 422 the parent media entity 404 and any children 406, 408, 410 thereof (or, to use another visual metaphor, any branch and any leaves thereof).

Other loaders, such as loader A 416 may be designed for loading other code and/or data, namely unsigned content A 180, or in the case of loader C 418, signed content A 168. By properly logically storing unsigned content and assigning the appropriate loader therefore, unsigned content can be properly isolated from other unsigned content (and other signed content).

FIG. 5 illustrates that at least two kinds of mechanisms can be used to assure proper isolation and security when storing unsigned code and/or data (or signed code and/or data, for that matter). The first mechanism uses a signed loader when accessing and/or loading unsigned content, such as a game 508—per the discussion above in reference to FIG. 4. The second mechanism can provide a security feature that uses a hardware key 504, which may be unique to a given computing device 510. This is to contrast such a key 504 with a typically used software key 502. Storage containers, such as the sandbox 500 shown in FIG. 5, can be signed by this hardware key 504, so that a hash can then be generated over such a container so that if the container is tampered with, such tampering is easily detectable. Put another way, the hardware key 504 can serve as a mechanism that enforces the bounds of the sandbox 500 so that no external code can access the game 508 contained therein. It should be noted that various implementations of the mechanisms discussed above can be implemented. In one aspect, the hardware key 504 can sign a certificate, such as X.509 certificate to provide the security mentioned security mechanism. Those of skill in art of cryptography will readily appreciate equivalent and similar mechanisms.

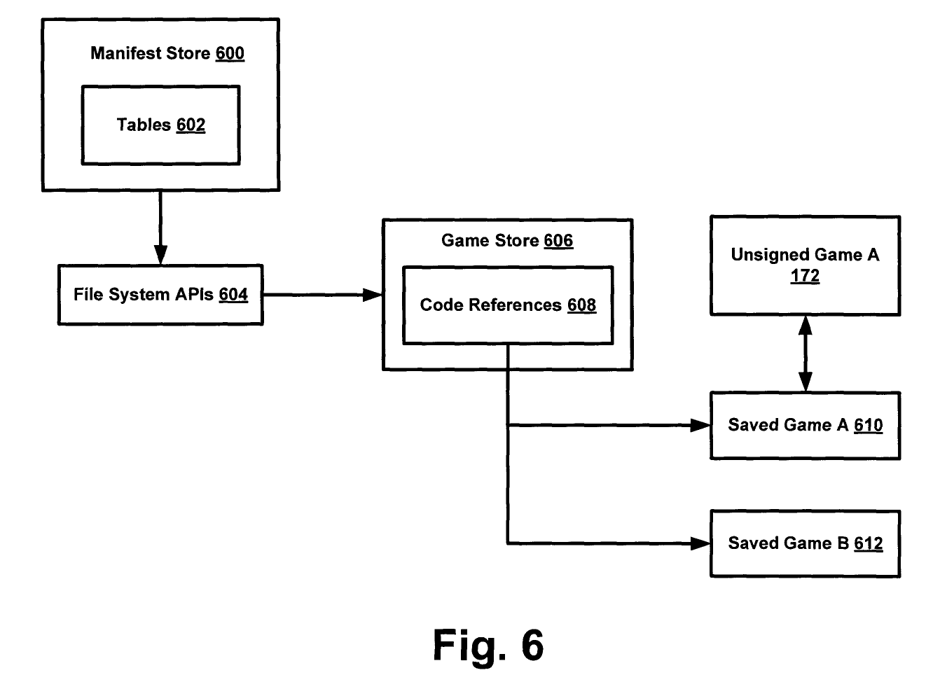

Next, FIG. 6 illustrates that a system view of one exemplary and non-limiting aspect of the present disclosure that includes various stores of code and/or data, along with accompanying application programming interfaces (APIs). Per FIG. 6, a manifest store 600 can have tables 602 with various game title names, descriptions, and the like. The manifest store 600 can use a file system API 604—an API found in a typical file system of any operating system employing file system structure to arrange code and/or data—to communicate with a game store 606. The game store 606 can have actual references 608 to saved games, such as game A 610 and game B 612. Any of these saved games can correspond to a particular game. For example, unsigned game A 172 can be saved as saved game A 610. By providing an interface, the manifest store 600 allows users to select games that are referenced in the game store 606, and that are invoked upon selection from a saved state. Of course, other interfaces than a manifest store 600 are contemplated herein, as those of skill in the art will readily appreciate.

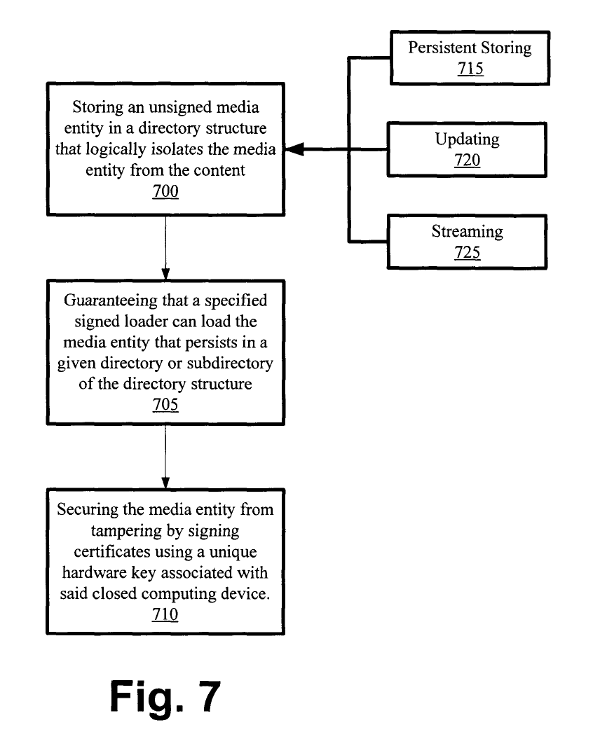

Next, FIG. 7 illustrates a flow chart of an exemplary and non-limiting method implementation of storing unsigned content in closed computing devices. At step 700, an unsigned media entity can be stored in a directory structure of a closed computing device, so that the media entity can be logically isolated from any other content, whether such content is stored locally on a console device or remotely (or a combination thereof). Such storing can include any one of (or a combination of) (a) persistent storing of the unsigned media entity, block 715, (b) updating of the unsigned media entity, block 720, and (c) storing real time streams of the unsigned media entity, block 725.

Then, at block 705, a guarantee can be made that a specified signed loader can load the media entity that persists in a given directory or subdirectory of the directory structure 705. This forms part of the sandboxing mechanism discussed above. Then, at block 710, to add to device security, the media entity can be secured from tampering by signing certificates using a unique hardware key associated with the closed computing device, per the discussion above. If any hierarchical isolation data is encoded therein, it can then reliably be compared against the location where the content was found ensure no external tampering with the isolation locations has occurred.

To summarize, in more abstract terms, this is a method for securely storing unsigned information in a closed computing device. Thus, such storing comprises storing at least one unsigned media entity in memory of the closed computing device, where the storing can further comprise preventing any content from accessing the at least one unsigned media entity (and vice-versa, in other aspects). It also includes isolating the at least one unsigned media entity from the content on a per unsigned media entity basis—i.e. the media entity is the unit of isolation (as opposed to, say, a set of media entities being the unit of isolation, or user accounts being the unit of isolation). In some exemplary and non-limiting aspects of the present disclosure, such isolation can mean that access to unsigned media entities is prevented from within a computing device (by other code stored on the computing device) and/or, moreover, external tampering can be prevented (i.e. by code outside the computing device). It should be noted that while the aforementioned storing is occurring, the closed computing device can be one physical device or a device distributed over a network (one logical device, but not necessarily one physical device).

### III. Exemplary Computing Devices and Networks For Storing Information

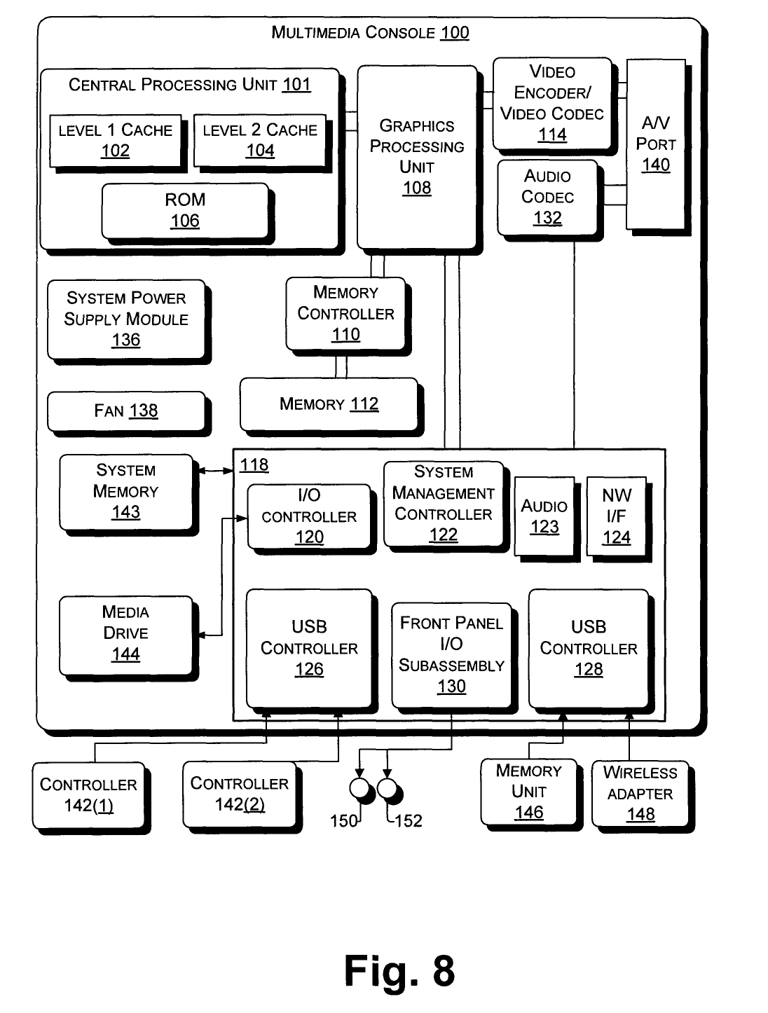

Gaming consoles can be used to store information, such as unsigned content, since such gaming consoles could be considered exemplary and non-limiting embodiments of the presently disclosed subject matter. Referring next to FIG. 8, a block diagram shows an exemplary multimedia console, whether a game oriented console or a general personal computer (PC). For example, digital audio processing may be implemented in the multimedia console 100. The multimedia console 100 has a central processing unit (CPU) 101 having a level 1 (L1) cache 102, a level 2 (L2) cache 104, and a flash ROM (Read-only Memory) 106. The level 1 cache 102 and level 2 cache 104 temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase may be stored in a FLASH memory device (not shown). Further, ROM 106 may be located separate from CPU 101.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity, 3D, surround, and stereo audio processing according to aspects of the present invention described above. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community. As such a participant, it may interact with computing devices, whether PCs or servers, and receive information that may be eventually stored.

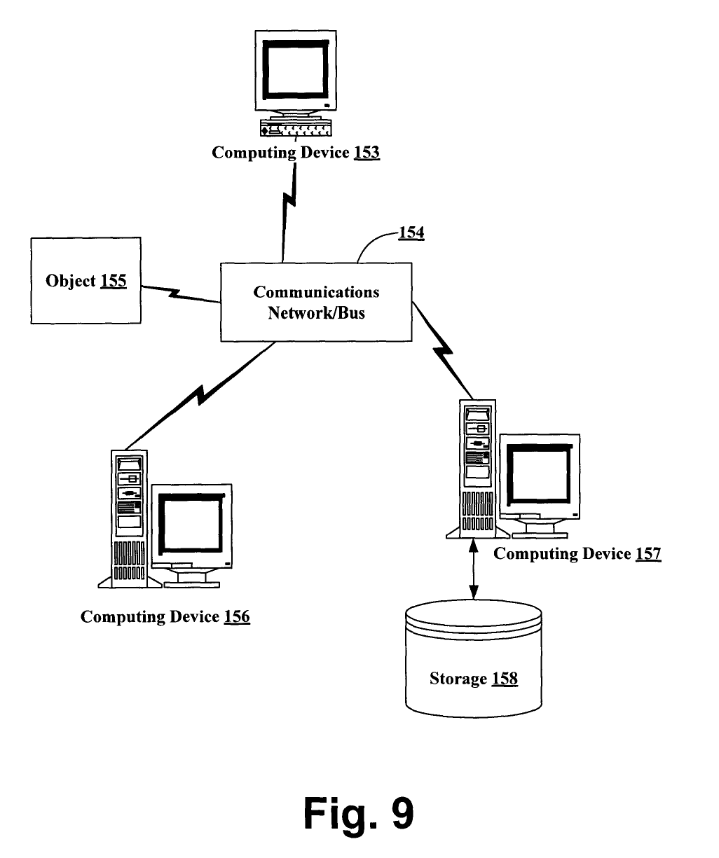

Thus, per FIG. 9, the console 100 can be some general computing device 153 that communicates with other computing devices 156, 157 over some communications network or bus 154. It may also communicate with other objects 155 that can be processes or threads within the computing device 153 or outside in other devices. Thus, in another aspect, the persistent storage 164 discussed with reference to FIGS. 1-3 can either reside on the console 100 (i.e. computing device 153) or it can be remote from the computing device 153, namely, stored remotely at 158. The particular residence of the persistent storage 164 will dependent on the embodiment used by parties implementing this disclosed subject matter.

Finally, it should also be noted that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined

Lastly, while the present disclosure has been described in connection with a plurality of exemplary aspects, as illustrated in the various figures, it is understood that other similar aspects may be used or modifications and additions may be made to the described aspects for performing the same function of the present disclosure without deviating therefrom. For example, in various aspects of the disclosure, processes and methods were described at least for storing unsigned content on gaming consoles. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for securely storing unsigned information in a closed computing device, comprising:
a subsystem that stores at least one unsigned game in memory of said closed computing device, wherein said storing further comprises:
preventing any content from accessing said at least one unsigned game;
preventing said at least one unsigned game from accessing any of said content;
isolating said at least one unsigned game from external tampering; and
isolating said at least one unsigned game from said content on a per unsigned game basis;

2. The system according to claim 1, wherein said storing further comprises storing said at least one unsigned game in a directory structure that logically isolates said at least one unsigned game from said content.

3. The system according to claim 1, wherein said closed computing device uses a directory structure to guarantee that only a specified signed loader can load said at least one unsigned game that persists in a given directory or subdirectory of said directory structure.

4. The system according to claim 1, wherein said at least one unsigned game in said closed computing device is secured from tampering by signing a certificate with a unique hardware key associated with said closed computing device.

5. The system according to claim 1, wherein said at least one unsigned game contains hierarchical isolation information within its own content, thereby allowing for isolation of said at least one unsigned game.

6. The system according to claim 1, wherein said content is one of (a) stored on a computing device remote from said closed computing device, (b) stored on said closed computing device, and (c) stored as a combination of (a) and (b).

7. The system according to claim 1, wherein said closed computing device is a device distributed over a network.

8. A method for securely storing unsigned information in a closed computing device, comprising:
storing at least one unsigned media entity in memory of said closed computing device, wherein said storing further comprises:
preventing any content from accessing said at least one unsigned media entity;
isolating said at least one unsigned media entity from external tampering; and
isolating said at least one unsigned media entity from said content on a per unsigned media entity basis.

9. The method according to claim 8, wherein said storing further comprises storing said at least one unsigned media entity in a directory structure that logically isolates said at least one unsigned media entity from said content.

10. The method according to claim 8, wherein said closed computing device uses a directory structure to guarantee that a specified signed loader can load said at least one unsigned media entity that persists in a given directory or subdirectory of said directory structure.

11. The method according to claim 8, wherein said at least one unsigned media entity in said closed computing device is secured from tampering via a unique hardware key associated with said closed computing device.

12. The method according to claim 8, wherein said at least one unsigned game contains hierarchical isolation information within its own content, thereby allowing for isolation of said at least one unsigned game.

13. The method according to claim 8, wherein said content is one of (a) stored on a computing device remote from said closed computing device, (b) stored on said closed computing device, and (c) stored as a combination of (a) and (b).

14. The method according to claim 8, wherein said closed computing device is a device distributed over a network.

15. A computer readable medium storing thereon computer executable instructions for securely storing unsigned information in a closed computing device, comprising:
an instruction that stores at least one unsigned media entity in memory of said closed computing device, wherein said instruction further also prevents one of (a) any content from accessing said at least one unsigned media entity, and (b) said unsigned media entity from accessing said content.

16. The computer readable medium according to claim 15, wherein said storing further comprises storing said at least one unsigned media entity in a directory structure that logically isolates said at least one unsigned media entity from said content.

17. The computer readable medium according to claim 15, wherein said closed computing device uses a directory structure to guarantee that a specified signed loader can load said at least one unsigned media entity that persists in a given directory or subdirectory of said directory structure.

18. The computer readable medium according to claim 15, wherein said at least one unsigned media entity in said closed computing device is secured from tampering via a unique hardware key associated with said closed computing device.

19. The computer readable medium according to claim 15, said at least one unsigned game contains hierarchical isolation information within its own content, thereby allowing for isolation of said at least one unsigned game.

20. The computer readable medium according to claim 15, wherein said content is one of (a) stored on a computing device remote from said closed computing device, (b) stored on said closed computing device, and (c) stored as a combination of (a) and (b).
